(19) United States
(12) Patent Application Publication
(10) Pub. No.: US 2012/0117741 A1
(43) Pub. Date: May 17, 2012

(54) WIPES FOR CLEANING COFFEE CUPS

(76) Inventor: Michael Patterson, Indianapolis, IN (US)

(21) Appl. No.: 12/947,152

(22) Filed: Nov. 16, 2010

(51) Int. Cl. B08B 1/00

(52) U.S. Cl. 15/104.93

(57) ABSTRACT

Wipe systems are provided for removing stains and residues from a utensil such as a coffee cup without leaving a harmful or distasteful residue and optionally bleaching and/or disinfecting the cup. The wipe system includes a first substrate impregnated with a cleaning material and a second substrate having absorbent properties. The first substrate can be pre-moistened or moistened prior to use. Suitable cleaning materials include aqueous acidic materials. The second substrate, which can be constructed from a paper material or a superabsorbent polymer, can be utilized to remove residual cleaning material following the cleaning procedure. The wiping system can also include a first substrate containing microencapsulated disinfecting and/or bleaching agents. The microencapsulated materials can be solid or liquid and are capable of rupturing to release the material during the cleaning process.

### TECHNICAL FIELD

The present novel technology relates to the field of cleaning products, and, more particularly, to a disposable substrate for cleaning a utensil such as for example a coffee cup.

### BACKGROUND

Coffee is a staple for most Americans, and is considered a necessity by many, on a par with air. In the business world, most coffee drinkers have their own coffee mugs that reside on their desks and are refilled several times a day. Unlike at home, coffee mugs in business settings may not be washed as routinely or as thoroughly, resulting in a buildup of coffee stains and other residue. Moreover, many people have their own coffee mugs or spill-resistant travel coffee cups that they take with them, and these may see extended use between washings. Further, in some office settings, a supply of common coffee cups is maintained for all users to draw from, and these may be of dubious cleanliness.

One remedy for these situations is to simply fill the basin with soap and water and wash a selected coffee cup prior to use. However, there may not be a basin handy, there may not be cleaning products available, and/or there may not be sufficient time available to properly clean the stains and residue from the selected cup. Another option is to use a pre-moistened wipe to clean the cup. However, such wipes are typically moistened with soap, which leaves an unpleasant residual taste and may not adequately remove the coffee stains or sanitize the cup. Thus, there is a need for a quick and easy means of removing coffee stains and residue from a coffee cup that does not leave residual soap therein and which can optionally sanitize the coffee cup and reduce any coffee stain that has developed. The present invention addresses this need.

### SUMMARY

The present novel technology relates to a wet cleaning substrate for removing stains and residue from utensils such as coffee cups. One object of the present novel technology is to provide an improved coffee mug cleaning system. Remaining objects and advantages of the novel technology will become apparent from the following descriptions.

One aspect of the present disclosure involves a wipe system for removing stains and residues from a coffee cup. The system includes a first pre-moistened substrate impregnated with a cleaning material capable of removing coffee and tea stains without leaving a harmful or distasteful residue, and a second dry substrate including an absorbent material, capable of absorbing any residual cleaning material from the cup after contact with the first substrate. Preferred cleaning materials are acidic materials. Suitable acidic materials include hydrochloric acid, acetic acid, phosphoric acid, p-toluenesulfonic acid, and combinations thereof.

A further aspect of the present disclosure involves a wipe system for removing stains and residues from a coffee cup comprising a substrate including a microencapsulated disinfecting and/or bleaching agent having antibacterial and bleaching properties. The microcapsules containing the disinfecting and/or bleaching agents are capable of breaking during the cleaning process to release the agents contained therein. Suitable microencapsulated disinfecting and/or bleaching agents can be a hypochlorite or a peroxide. Sodium and calcium hypochlorite are particularly suitable hypochlorites and hydrogen peroxide and calcium peroxide are particularly suitable peroxides.

A still further aspect of the present disclosure involves a wipe system for cleaning and removing stains and/or residues from a utensil. The wipe system includes a substrate impregnated with a cleaning material, a disinfecting agent, and/or a bleaching agent capable of removing food and drink residue, disinfecting, and reducing a stain without leaving a harmful or distasteful residue. A single agent may serve as both the disinfecting agent and the bleaching agent. Preferred cleaning materials, disinfecting agents, and/or bleaching agents are microencapsulated and released during the cleaning process. Preferred wipe systems further include a second substrate constructed from an absorbent material. Preferred absorbent materials include paper and superabsorbent polymers. Although the cleaning material, the disinfecting agent, and/or the bleaching agent can be incorporated into the body of the substrate, preferred substrates have a laminate structure with the cleaning material and/or the disinfecting and/or bleaching agents trapped between the layers within pockets formed between the layers.

### DESCRIPTION OF THE DRAWINGS

For a better understanding of the nature and objects of the present novel technology, reference should be made to the following drawings, in which:

FIG. 1 shows a schematic depiction of a sheetlike substrate of a wipe system according to a first embodiment having a cleaning material incorporated within the substrate.

FIG. 2 shows a schematic depiction of a sheetlike substrate of a wipe system constructed from an absorbent material suitable for removing residual cleaning material from a cleaned utensil.

FIG. 3 shows a schematic sectional depiction of a laminated sheetlike structure containing regions of trapped microencapsulated cleaning, disinfecting, and/or bleaching material.

FIG. 4 shows a schematic depiction of a partially folded sheet-like substrate having a pre-moistened cleaning portion and a dry absorption portion connected through a non-porous region, the two portions separated by a water impermeable sheet.

### DETAILED DESCRIPTION

For the purposes of promoting an understanding of the principles of the novel technology, reference will now be made to the preferred embodiments thereof, and specific language will be used to describe the same. It will nevertheless be understood that no limitation of the scope of the novel technology is thereby intended, such alterations, modifications, and further applications of the principles of the novel technology being contemplated as would normally occur to one skilled in the art to which the novel technology relates.

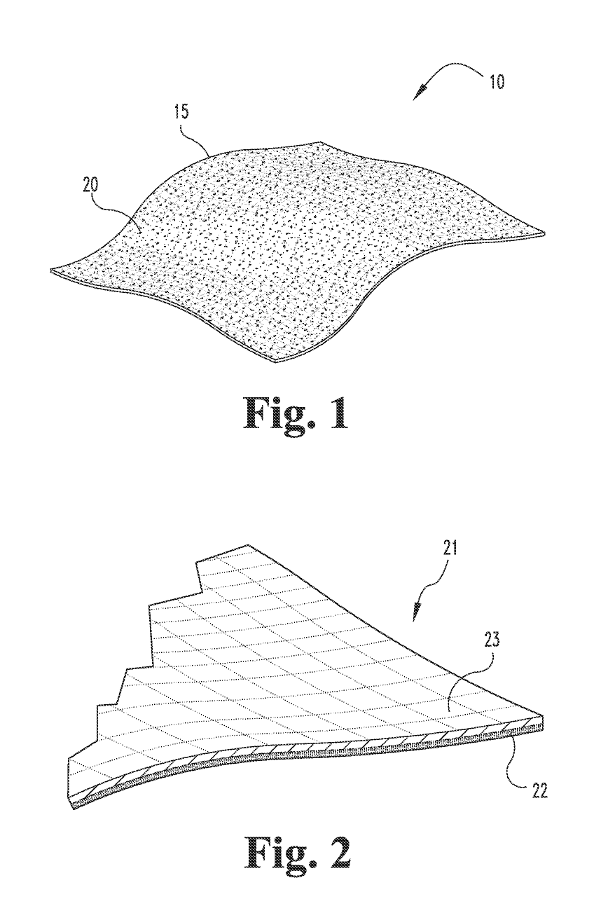

The present novel technology, as illustrated herein, relates to a moistened or pre-moistened cleaning substrate or ‘wipe’ system 10 for removing stains and residue from coffee mugs. The system 10 includes a substrate 15 impregnated or saturated with a cleaning material 20. The substrate 15 may be any material having sufficient wet strength, absorbency, abrasivity, and porosity characteristics. The substrate 15 is typically paper, but may be selected from any convenient woven material, nonwoven material, hydro-entangled material, sponge material, or the like, with or without an abrasive surface region. FIG. 1 illustrates a wipe system 10 that includes substrate 15 impregnated with cleaning material 20.

The cleaning material 20 can be aqueous and either neutral, acidic, or basic. The cleaning material 20 preferably is able to substantially remove coffee or tea stains and residue without substantially contributing a residual flavor or leaving a toxic or harmful residue. For other embodiments, cleaning material 20 may include acidic or basic components capable of disinfecting and bleaching the cup to remove or reduce coffee stains and disinfect the cup. The cleaning material 20 is typically not dilute enough so as to not damage clothing if the system 10 comes into contact therewith, as it is sufficiently concentrated so as to effectively remove coffee stains.

For certain embodiments, the cleaning material 20 may include dilute hydrochloric acid, acetic acid, phosphoric acid, p-toluenesulfonic acid and the like or combinations thereof. Other embodiments may contain a combination of components capable of cleaning and generating bleaching and/or disinfecting agents. For example, the combination of a metal hypochlorite and an acid can result in the generation of chlorine providing both a bleaching and disinfecting action. The use of a slight excess of the acid would provide a further cleaning action. Finally, a dry substrate incorporating calcium peroxide can, upon being moistened, generate hydrogen peroxide and ultimately oxygen providing both a bleaching and disinfecting action.

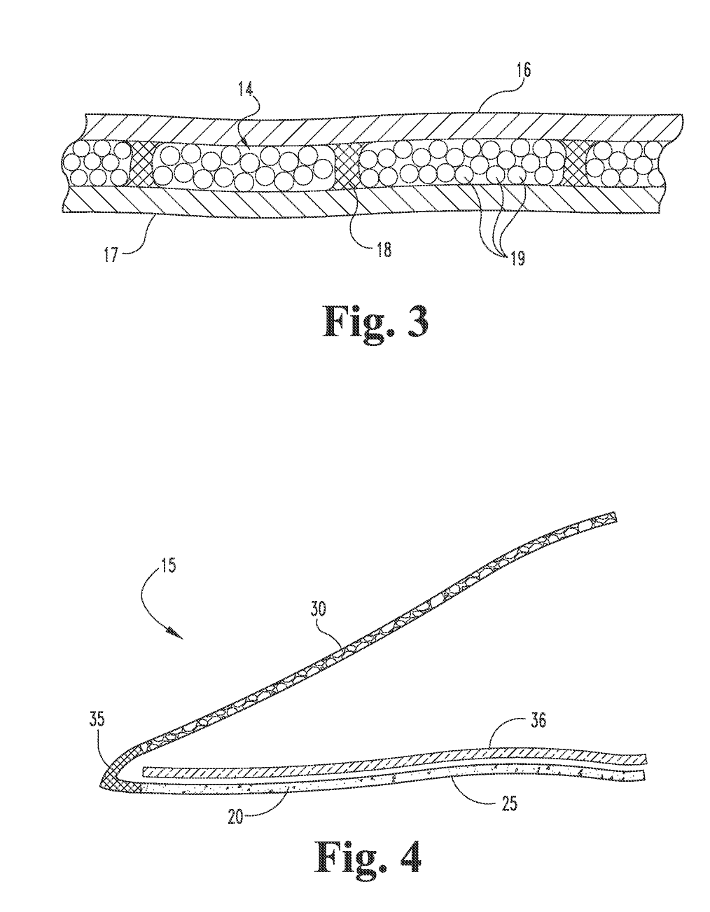

For combinations such as, for example, a bleaching/disinfecting agent such as sodium hypochlorite and one or more acids, one or a combination of the components can be microencapsulated to prevent reaction until the cleaning action ruptures the microcapsules initiating the cleaning, disinfecting and bleaching action of chlorine. For example, an aqueous mixture of phosphoric acid and p-toluenesulfonic acid can be microencapsulated utilizing the following techniques:
a.) by coating droplets of the aqueous solution with hydrophobic fused silica, a free flowing powder containing the aqueous solution can be formed and incorporated into substrate 15; or
b.) the aqueous solution can be combined with a melted wax having a melting point below 100° C., the two phase mixture sprayed into droplets, and the droplets cooled to incorporate the aqueous solution inside a wax microcapsule suitable for incorporation into substrate 15.
   An aqueous solution of a metal hypochlorite can be similarly microencapsulated. Other methods for microencapsulating an aqueous solution are known to those skilled in the art. Solid components, including microencapsulated liquids, can be trapped within substrate 15, maintained therein utilizing an adhesive material, or be trapped within a laminate structure. FIG. 3 illustrates the wipe system 10 having a laminate structure. Wipe system 10 includes layers 16 and 17 held together with adhesive 18. Cleaning materials, and optionally disinfecting and/or bleaching agents 19, are trapped within pockets 14.

For combinations including a solid and an aqueous liquid component, system 10 can include substrate 15 containing a solid component that is activated by wetting prior to use. An example of a solid component is calcium peroxide which is activated by contact with water to generate calcium hydroxide, hydrogen peroxide and ultimately molecular oxygen. The calcium hydroxide produced has low water solubility, is generally nontoxic, and has been utilized as an antibacterial agent in the dental field. The hydrogen peroxide produced similarly provides a further antibacterial and bleaching effect. A form of microencapsulated calcium peroxide is preferred. The calcium peroxide utilized is preferably microencapsulated. Microencapsulated calcium peroxide is generally safe and has been utilized as a dentifrice.

A second substrate 21 constructed from an absorbent material can also be utilized to remove any residual cleaning material from a cup after the cleaning process. Although the absorbent material can generally be constructed of any paper, cloth, or the like, a superabsorbent polymer of the type utilized in disposable diapers is preferred. One type of superabsorbent material is an acrylic acid polymer. The second substrate 21 should be capable of fully absorbing any residual liquid remaining on the utensil leaving its surface substantially dry and clean. FIG. 2 illustrates a second substrate 21 constructed by forming a layer of superabsorbent polymer 22 on a second layer defined by a paper sheet 23.

The examples of cleaning materials 20 provided above are intended to be illustrative and are not intended to limit the disclosure to a specific cleaning material 20. The combination of p-toluenesulfonic acid and phosphoric acid is particularly useful as a component of cleaning material 20 and their residues have minimal effect on taste when the cleaned cup is subsequently used. Components of cleaning materials 20 that disinfect and/or bleach can be utilized in amounts that generate the active agent such as molecular chlorine or hydrogen peroxide in levels sufficient to provide an antibacterial effect and/or at least some bleaching effect, but as sufficiently low levels that toxicity and dermatological problems are avoided. The level(s) of cleaning materials 20 should also be maintained sufficiently low to avoid any effect on taste when the cup is utilized after cleaning. For disinfecting/bleaching materials considered thus far, the active component, such as for example, chlorine, hydrogen peroxide, or calcium hydroxide, is preferably present in the aqueous phase within a moistened system 10 at a level of less than about 10 wt. %, more preferably at less than about 6 wt. %, and most preferably at less than about 3 wt. %.

In one embodiment, illustrated in FIG. 4, the substrate 15 is provided in two portions 25, and 30. The first portion 25 is impregnated with the cleaning solution 20 and optionally a disinfecting and/or bleaching agent, while the second portion 30 is includes an absorbent material. The portions 25, 30 may be connected as part of a unitary substrate 15, connected through a connecting region, 35. Preferred connecting regions 35 are constructed from a non-porous material. Unitary substrate 15 can be folded for packaging with a water impermeable sheet 36 between each portion 25 and 30, to maintain portion 30 in a dry state. In addition, portions 25 and 30 may be provided separately and each packaged separately. Preferred absorbent materials include paper and superabsorbent polymers.

In operation, an individual wipe 15 is applied to the stained mug or vessel with a rubbing motion. The stain is lightly scrubbed with the wipe 15, and, more specifically, the portion 25 of the wipe saturated in cleaning solution 20, allowing the cleaning solution 20 to begin to attack any present stains and residue. The combination of chemical dissolution and mechanical scrubbing substantially removes stains and residue from the mug. The mug may then be rinsed, either with water or with a dry wipe portion 30 to absorb any residual cleaning solution 20.

While the novel technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the novel technology are desired to be protected.

We claim:

1. A wipe system for removing stains and residues from a coffee cup comprising a first pre-moistened substrate impregnated with a cleaning material capable of removing coffee and tea stains without leaving a harmful or distasteful residue, and a second dry substrate including an absorbent material, capable of absorbing any residual cleaning material from the cup after contact with the first substrate.

2. The wipe system of claim 1, wherein the cleaning material is acidic, and the absorbent material is a superabsorbent polymer.

3. The wipe system of claim 2, wherein the cleaning material is selected from the group consisting of hydrochloric acid, acetic acid, phosphoric acid, p-toluenesulfonic acid, and a combination thereof and the superabsorbent polymer is derived, at least in part from acrylic acid.

4. The wipe system of claim 2, wherein the cleaning material is a combination of phosphoric acid and p-toluenesulfonic acid.

5. A wipe system for removing stains and residues from a coffee cup comprising a substrate including a microencapsulated disinfecting and/or bleaching agent having antibacterial and bleaching properties.

6. The wipe system of claim 5, wherein the disinfecting and/or bleaching agent is selected from the group consisting of a hypochlorite, and a peroxide.

7. The wipe system of claim 6, wherein the disinfecting and/or bleaching agent is a metal hypochlorite and the system further includes a microencapsulated acid.

8. The wipe of claim 6, wherein the disinfecting and/or bleaching agent is a peroxide.

9. The wipe of claim 8, wherein the disinfecting and/or bleaching agent is a metal peroxide.

10. The wipe system of claim 5, further including a second substrate derived from an absorbent material, capable of absorbing any residual disinfecting and/or bleaching agent from the cup.

11. The wipe system of claim 10, wherein the absorbent material is a superabsorbent polymer.

12. A wipe system for cleaning and removing stains and/or residues from a utensil comprising a substrate impregnated with a cleaning material capable of removing food and drink residue without leaving a harmful or distasteful residue wherein said substrate further includes a disinfecting and/or bleaching agent.

13. The wipe system of claim 12, wherein said cleaning material and said disinfecting and/or bleaching agent are microencapsulated and are released during said cleaning and removing.

14. The wipe system of claim 13, wherein the substrate is a laminate substrate having at least two layers and containing said microencapsulated cleaning material and disinfecting and/or bleaching agent therebetween.

15. The wipe system of claim 14, wherein said at least two layers are held together with an adhesive.

16. The wipe system of claim 15, wherein the cleaning material and the disinfecting and/or bleaching agent are released from the microcapsules during the cleaning process.

17. The wipe system of claim 12, further including a second substrate derived from an absorbent material, capable of absorbing any cleaning material and/or residual disinfecting and/or bleaching agent from the utensil.

18. The wipe system of claim 17, wherein the absorbent material is a superabsorbent polymer.
